(19) United States
(12) Patent Application Publication
(10) Pub. No.: US 2008/0148556 A1
(43) Pub. Date: Jun. 26, 2008

(54) DEVICE FOR THE CONNECTION/DISCONNECTION OF TWO ELEMENTS FROM A RELATIVE AXIAL MOVEMENT BETWEEN THESE TWO ELEMENTS

(75) Inventors: Jean-Philippe Connan, Le Havre (FR); Marin Clausin, Villerville (FR)

Correspondence Address: BROWDY AND NEIMARK, P.L.L.C.;624 NINTH STREET, NW, SUITE 300, WASHINGTON, DC, 20001-5303, US

(73) Assignee: Karver, Honfleur (FR)

(21) Appl. No.: 11/875,514

(22) Filed: Oct. 19, 2007

(30) Foreign Application Priority Data
Dec. 21, 2006 (FR) 06 11213
Aug. 2, 2007 (FR) 07 05723

(51) Int. Cl. B23P 19/00

(52) U.S. Cl. 29/700

(57) ABSTRACT

The device according to the invention allows a connection/disconnection of two elements from a relative axial movement of these two elements, the two elements being able to achieve, at the end of an assembly travel, an assembled position, then to perform, beyond this assembly position, an overtravel, one of said elements comprising a locking member able to go successively from a released position to a locked position in which it cooperates with the other element to provide said locking.

This device comprises means for actuating the locking member from said overtravel, such that a first overtravel causes the locking member to go from the released position to the locked position, and such that the following overtravel returns the locking member to the released position.

### BACKGROUND OF THE INVENTION

1. Field of the Invention

The present invention relates to a device for the connection/disconnection of two elements from a relative axial movement between these two elements under the effect of an axial force exerted in a same direction.

It is applicable in particular to a connection with locking/unlocking between two elements one of which, hereinafter “support element”, is connected to a fixed structure such as, for example, the head of a sailboat mast, while the other is releasable and may be connected to a releasable device such as a sail.

2. Description of the Prior Art

In general, one knows that many connection devices have been proposed which comprise an unlocking function, but none of these make it possible to respect all operational constraints, and to obtain an assembly which meets the criteria of mass, space and cost, criteria which are all essential in designing and producing high-performance elements in the sailboat field.

Thus, in particular, patent FR No. 2 794 100 proposes a ball lock apparatus released by an outer bushing. This solution does not allow transmission of significant exertions. It also requires a degree of freedom between the end of the control line and the releasable assembly, which does not allow disconnection of the releasable assembly from the body by applying an effort on the releasable assembly in the direction of the body.

In patent applications FR 06 01126 and 05 09617 filed in the name of Marin Clausin, a device of the abovementioned type has already been proposed wherein one of the two elements comprises a body, which is at least partially hollow, and which defines an open cavity on one side by an access opening and is provided with radially mobile bolts stressed by elastic means toward the inside of said cavity. The second element comprises a stud able to be engaged in said cavities while pushing the locks into a locking position wherein the locks engage under the stud to provide locking. Unlocking is then also provided thanks to an unlocking part, preferably annular, axially mobile relative to the stud and arranged such that it can be moved axially by the second element from the locking position into an unlocking position in which it acts on the locks to separate them, thereby releasing the stud and providing, as a result, unlocking of the two elements.

This device has the advantages of being compact, light, inexpensive to produce, and while being able to accept, without breaking, very significant tensile stresses of several hundred kilonewtons and respecting the operational and ergonomic criteria making it possible to:
simply position the two elements to be assembled, for example thanks to the halyard serving to hoist the sail,
place and lock the two elements to be assembled by applying a first, weak effort (for example, on the halyard) to bring together the two elements to be assembled,
unlock and separate the two elements to be disassembled by first applying a second effort (for example, on the halyard) to bring together the two elements to be disassembled, then by separating the two elements, which can then be disassembled by applying a practically nonexistent outwardly-directed force.

### OBJECT OF THF INVENTION

The invention more relates to a device of this type having an even simpler design and only involving, for locking/unlocking, rotationally mobile parts, so as to reduce frictional forces and risks of jamming of the device as much as possible.

### SUMMARY OF THE INVENTION

To this end, it proposes a connection/disconnection device for two elements able to be assembled together, so as to achieve, at the end of an assembly travel, an assembled position, then beyond this assembled travel, to perform a locking/unlocking overtravel, one of said elements comprising a locking member in the assembled position of the two elements, this member being able to go successively from a released position in which it allows the assembly and disassembly of the two elements, to a locked position in which it cooperates with the other element to provide said locking.

According to the invention, this device comprises means for actuating the locking member from said overtravel, these means having a bistable operation, such that a first overtravel causes the passage of the locking member from the released position to the locked position and in that the following overtravel returns the locking member to the released position.

Advantageously, one of the two elements (the first) may comprise a rotary annular locking member having two axially distant cam profiles, designed to cooperate with two axially distant stop surfaces provided on the second element, the first cam profile be designed so as to cause rotation of the locking member under the action of the first stop surface, during said overtravel.

The second cam profile is designed so as to cooperate with the second stop surface of the second element, so as to cause rotation of the locking member and to axially hold this second element in the assembly position when the locking member is in the locked position.

According to a first embodiment of the invention, said first element of the female type may comprise a tubular body wherein a locking member is rotationally mounted comprising a tubular section having a cylindrical shape inside which are arranged:

on one hand, a coaxial crown whereof one of the radial surfaces is formed so as to constitute a cam surface having four successive notches each having a straight front followed by a partially cylindrical portion and a slightly tilted ramp,
on the other hand, a coaxial cylindrical part having an axial through passage with a rectangular cross-section centered on the axis of the tubular sleeve, said cylindrical part being located away from the crown and having, on the side of this crown, a radial surface comprising four successive notches similar to those of the crown and also comprising a straight front, a partially cylindrical portion and a slightly tilted ramp.

The notches of said crown are angularly offset relative to the notches of the cylindrical part.

The rectangular passage is arranged coaxially to the partially cylindrical portions of the two notches opposite the cylindrical part.

In this embodiment, the second element, of the male type, may comprise a cylindrical rod ending with a head comprising two protuberances centered perpendicularly to the rod, the rod/head assembly being T-shaped, the axial cross-section of the section being substantially equal to the straight cross-section of said axial passage.

According to another embodiment of the invention, one of the two elements comprises a locking member consisting of at least two axially distant cam profiles, designed to cooperate respectively with at least first and second stop surfaces provided on the second element, the first cam profile being designed so as to cause a relative rotation between the locking member and said stop surfaces following the effort exerted during said overtravel, between the first stop surface and said profile. The second cam profile is then designed so as to cooperate with the second stop surface of the second element so as to cause a relative rotation between the locking member and said stop surfaces during a return travel, opposite the overtravel, to the assembly position, and thereby to bring the locking member and/or the second stop into the locked position.

Advantageously, said first element may consist of a male-type support assembly bearing a locking member comprising two axially offset indented crowns forming said cam profiles. The second element may also consist of a releasable assembly comprising a rotary tubular body bearing said stop surfaces.

In this case, one of said crowns (the upper crown) may have a continuous succession of teeth, oriented downwardly, which forms the first cam profile. This succession may comprise at least two groups of teeth, preferably three groups of teeth, each extending over 120°.

Likewise, the lower crown may comprise at least two groups of cam profiles, preferably three groups, located at 120° from each other and separated by axial passages, here three axial passages at 120°.

The tubular body of the releasable assembly may comprise at least two protuberances, here three protuberances, formed so as to be able to go through said passage.

### BRIEF DESCRIPTION OF THE DRAWINGS

Embodiments of the invention will be described below, as non-exhaustive examples, in reference to the appended drawings in which:

FIGS. 1 and 2 are two views of a first embodiment of the device according to the invention, in elevation (FIG. 1) and axial cross-section following A/A from FIG. 1 (FIG. 2), respectively;

FIGS. 3 to 5 are partial diagrammatic views showing different stages of operation of the device illustrated in FIGS. 1 and 2: locking stage (FIG. 3), beginning of unlocking (FIG. 4), end of unlocking (FIG. 5);

FIG. 6 is a partial perspective view showing the two elements in the disassembled position;

FIG. 7 is a perspective view of a cylindrical part having a cam profile serving to perform locking and unlocking;

FIGS. 8 and 9 are two views in elevation (FIG. 8) and axial cross-section (FIG. 9), respectively, of one embodiment of the device according to the invention;

FIGS. 10 and 11 are views of a second embodiment of the device according to the invention, in elevation (FIG. 10) and axial cross-section at 90° of FIG. 10 (FIG. 11);

FIG. 12 is a developed diagrammatic view of the crowns of the tubular section of the male part.

### DESCRIPTION OF THE PREFERRED EMBODIMENTS

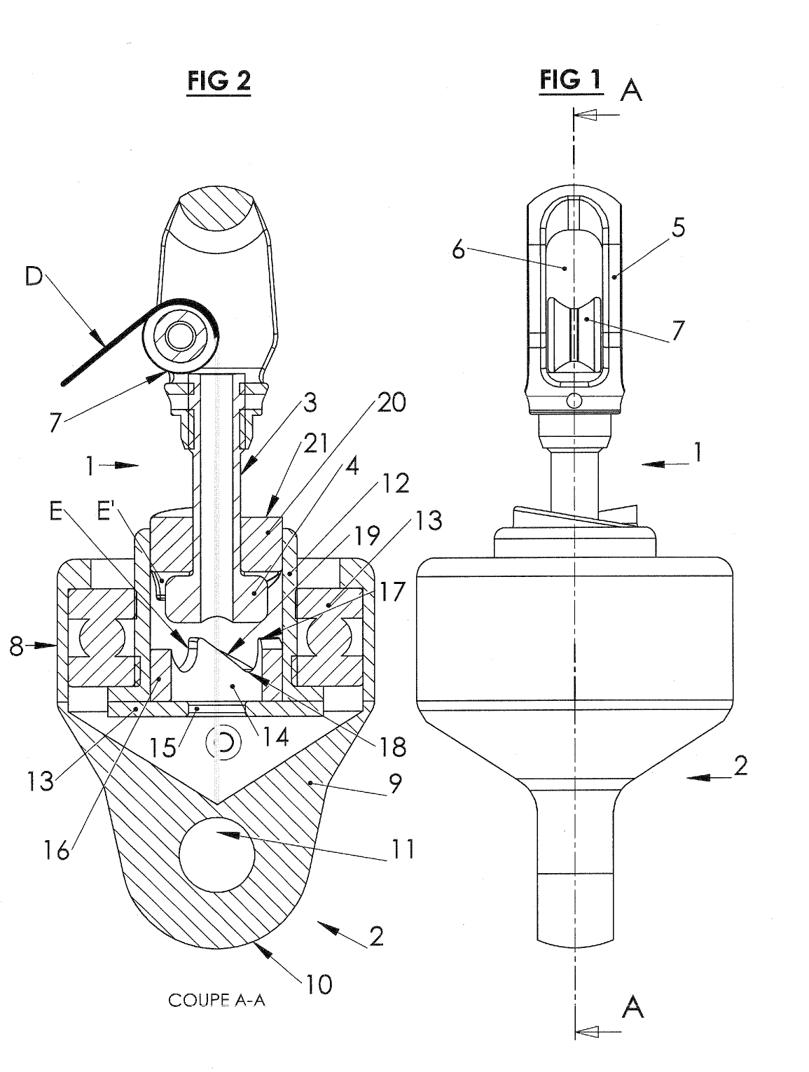

In the example illustrated in FIGS. 1 to 5, the connection/disconnection device comprises a support assembly 1 and a releasable assembly 2. The support assembly 1, of the male type, comprises an axially hollow rod 3 consisting on one hand of a head formed by a cylindrical section 4 centered perpendicularly to the rod 3 and made integral with said rod in its central part, and on the other hand of a yoke 5 defining a radial through passage having an oblong cross-section 6, wherein is rotationally assembled a pulley 7 over which passes a halyard D serving to hoist the releasable assembly 2 as well as to provide the release command for the device. After its passage on the pulley 7, this halyard D coaxially engages inside the rod 3, then, through a coaxial bore made in the section 4 before becoming fixed in the releasable assembly 2.

The upper part of the yoke 5, which has a rounded edge, constitutes a fastening guide making it possible to connect the support assembly 1, for example at the head of a sailboat mast.

The releasable assembly 2 comprises a cylindrical tubular body 8 open on one side and closed, on the other side, by a solid back 9 extended by a protuberance 10 provided with a fastening guide 11 for example, on which the head of a sail may be fastened.

Inside the body 8 is rotationally assembled a coaxial tubular sleeve 12, for example through a ball bearing 13, the body 8/sleeve 12 assembly forming a swivel.

The tubular sleeve 12 is open opposite the back 9 and is closed on the other side by a radial part 14 having the shape of a disk provided with a central bore 15.

It contains, on the side of the radial part 14, a coaxial crown 16 whereof the radial surface, located on the side opposite the back, is formed so as to constitute a closed loop cam surface having two opposite pairs of notches E centered perpendicularly to each other, each notch successively having a straight front 17, a cylindrical portion 18 and a slightly tilted ramp 19.

The tubular sleeve also contains, at the level of its opening, a coaxial cylindrical part 20 having an axial through passage 21 provided with a rectangular cross-section substantially equal to the axial cross-section of the cylindrical section 4 of the support assembly 1, this cross-section being centered on the axis of the cylindrical sleeve 12.

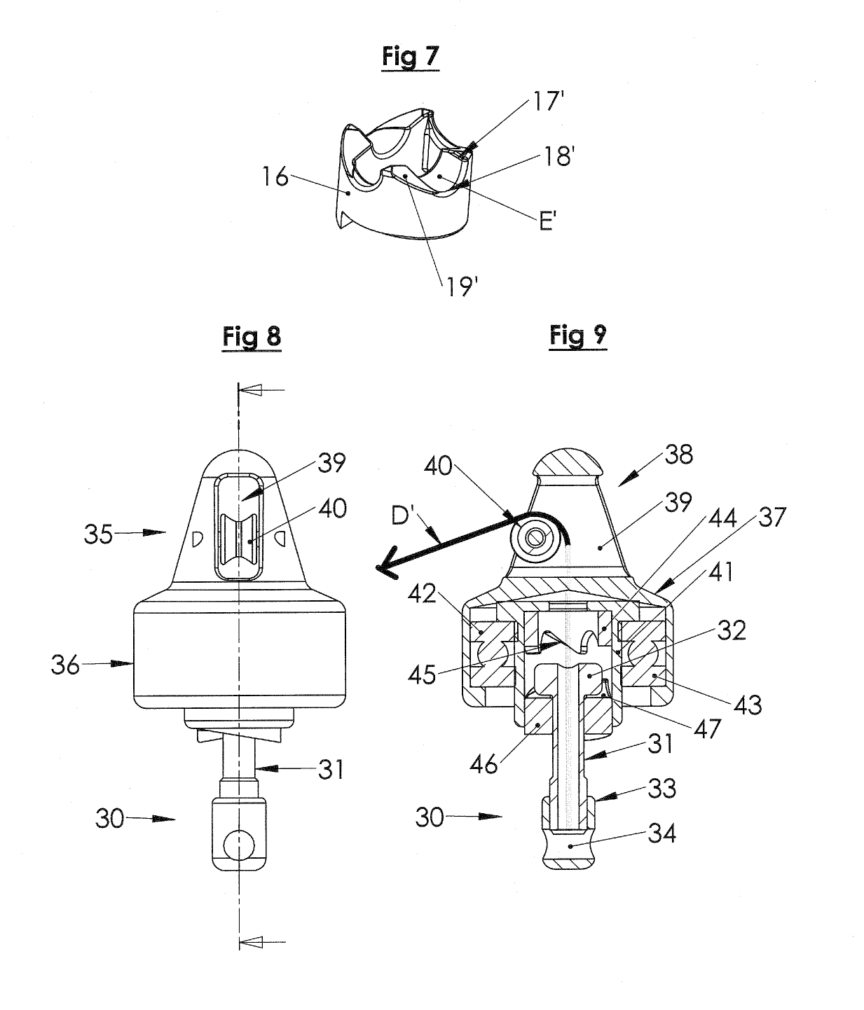

This cylindrical part 20, which is located away from the crown 16, has, on the side of this crown, a radial surface comprising two pairs of notches E′ similar to the notches E and each comprising a straight front 17′, a partially cylindrical portion 18′ and a slightly tilted ramp 19′ (FIG. 7). Here also, the two notches E′ of a same pair are symmetrical relative to the axis of the cylindrical part 20. The notches of the cylindrical part 20 are angularly offset relative to those of the crown 16.

The operation of the device described above is then as follows.

First, in order to engage the releasable assembly 2 on the support assembly 1, the operator exerts tension on the halyard D whereof the upper end, after passing through the rod 3, engages in the cylindrical sleeve 12, passing through the opening 15 of the radial part 13 whereon it is held, for example by a knot.

Under the effect of this tension, the removable assembly 2 passes through the position indicated in FIG. 6 until the cylindrical section 4 engages through the passage 21, exceeds the assembly position and completes an overtravel at the end of which it abuts on the ramp 19 of the crown 16, thereby causing the rotation of the rotary locking member formed by the section 12, the crown 16 and the cylindrical part 20.

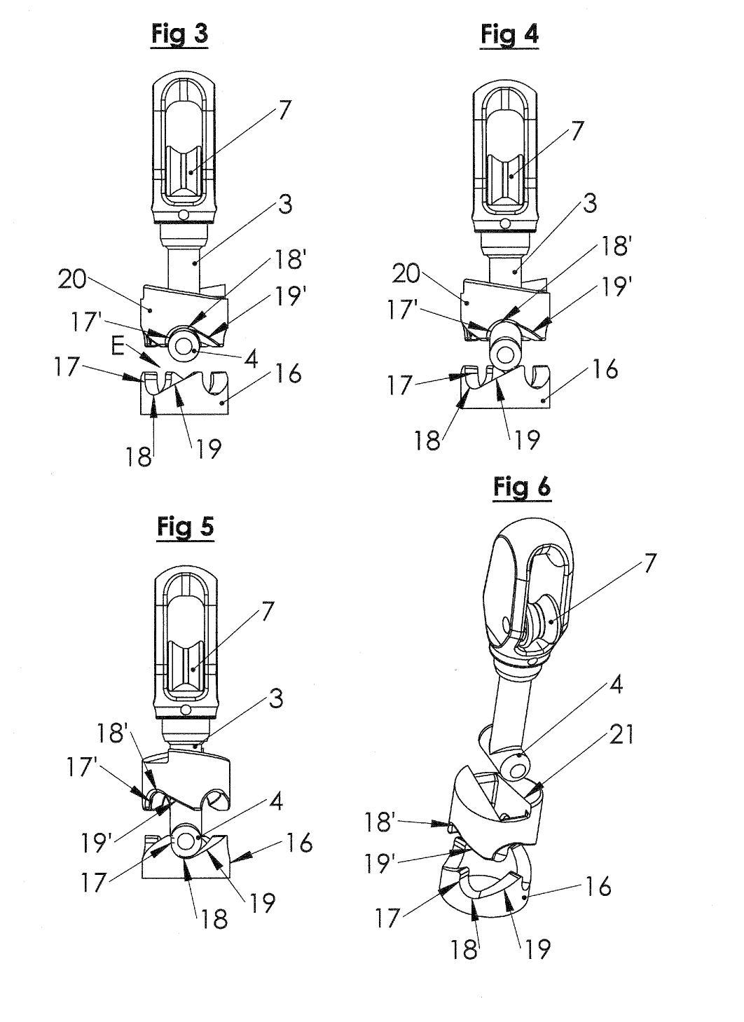

The operator then stops acting on the halyard. The releasable assembly performs a withdrawal movement of a length substantially equal to that of the overtravel. At the end of this withdrawal movement, the cylindrical section 4 abuts on the ramp, causing a new rotation of the rotary assembly until the section is engaged on the ramp 19′, then in the semi-cylindrical portion 18′ after having caused the rotation of the crown 16/cylindrical part 20 assembly. The cylindrical section 4 then remains in the semi-cylindrical portion, in the locked position of the device (FIG. 3).

Unlocking in order to release the element 2 is done by exerting new tension on the halyard D to cause a relative movement of the two elements of a size substantially equal to that of the overtravel.

At the end of this travel, the cylindrical section 4 once again abuts on the ramp 19 of the crown 16, causing rotation of the locking member until it engages in the partially cylindrical notch 18′. In this position, the section 4 is centered in the extension of the passage 21.

Following a release of the halyard by the operator, the releasable assembly 2 begins a descending motion which extends beyond the overtravel zone due to the fact that the section 4 engages in the passage 21 and that as a result, it is no longer held by the support assembly 1.

One important advantage of the solution described above is that the releasable connection/disconnection element 2 uses the same rotary assembly both to provide the locking/unlocking function and the traditional swivel function.

Of course, the invention is not limited to the embodiment previously described.

Thus, for example, contrary to the preceding solution, the releasable assembly 30 may be of the male type and comprise an axially hollow rod 31 comprising a head formed by a cylindrical section 32 similar to the head previously described with regard to FIG. 1 to 7. Nevertheless, in this case, the rod 31 is extended, opposite the head 32, by a portion 33, having a greater diameter, provided with a transverse bore 34 which constitutes a guide on which the head of a sail may be fastened.

The support assembly 35 is then of the female type and comprises a cylindrical tubular body 36 open on one side and closed, on the other side, by a solid back 37 extended by a protuberance 38 provided with an oblong recess 39 whereof the upper part forms a fastening guide allowing fixing of the support assembly, for example, on the mast head.

The lower part of the recess 39 constitutes a yoke wherein is pivotably assembled a pulley 40 over which passes a halyard D′ serving both to hoist the sail and provide the lock/unlock command for the releasable assembly 30.

Similarly, inside the body 36, is rotationally mounted a coaxial tubular sleeve 41 through bearings 42, 43.

This tubular sleeve 41 also contains a coaxial crown 44 whereof the radial surface forms a cam surface comprising two pairs of notches 45 similar to the notches E and a coaxial cylindrical part 46 provided with an axial passage having a rectangular cross-section and with a surface comprising two pairs of notches 47 similar to the notches E′.

After its return by the pulley 40, the halyard D′ passes through the support element 38, substantially coaxially to said support element, before engaging in the rod 31 of the releasable element 30 wherein it is fixed.

The operation of this device is substantially the same as that illustrated in FIGS. 1 to 5 and therefore will not be described again.

In the examples described above, the cam surfaces supported by the crown 16, 44 and the cylindrical sleeve 20, 46 cooperate with stops supported by a male element formed by a coaxial rod 3, 31.

Of course, these stops may be supported by a female element, for example, a tubular element coaxially engaging around said crown 16, 44 and said cylindrical sleeve 20, 46. In this case, the crown 16, 44 and the sleeve 20, 46 may be made integral through an internal structure, for example a coaxial tubular element through which the halyard D, D′ can pass.

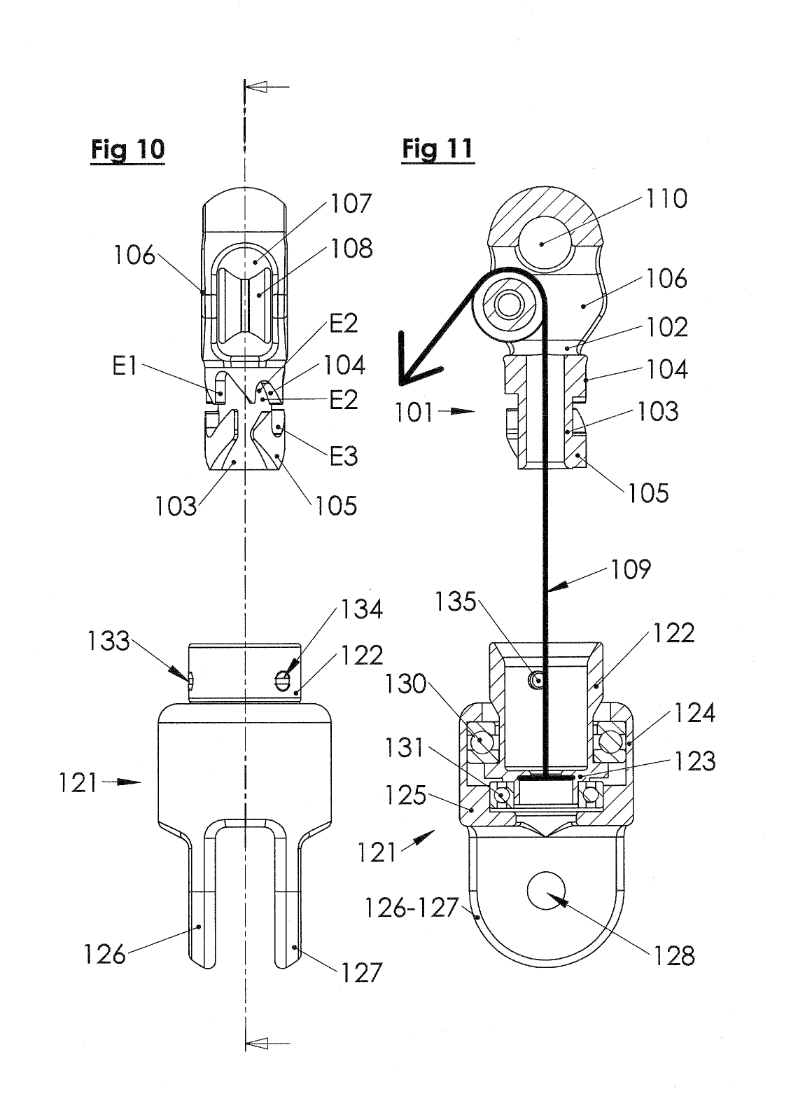

In the example illustrated in FIGS. 10 to 12, the support assembly 101, of the male type, comprises a rod 102 comprising, on one hand, a cylindrical tubular section 103 supporting, on its outer cylindrical surface, two axially offset indented crowns 104, 105. This cylindrical section 103 is open on one side (toward the bottom) and is made integral, on the other side, with a yoke 106 which defines a radial through passage 107, having an oblong cross-section, wherein is rotationally assembled a pulley 108 on which a halyard 109 passes serving to hoist the releasable assembly as well as to provide the locking/unlocking control of the device.

After its passage on the pulley 108, this halyard 109 engages in the cylindrical section 103 through a passage formed between this section 103 and the yoke 106, before being fixed in the releasable assembly.

The upper part of this yoke 106 has a solid form provided with a radial passage 110 forming a guide serving for the fastening of the support assembly for example on the head of a mast.

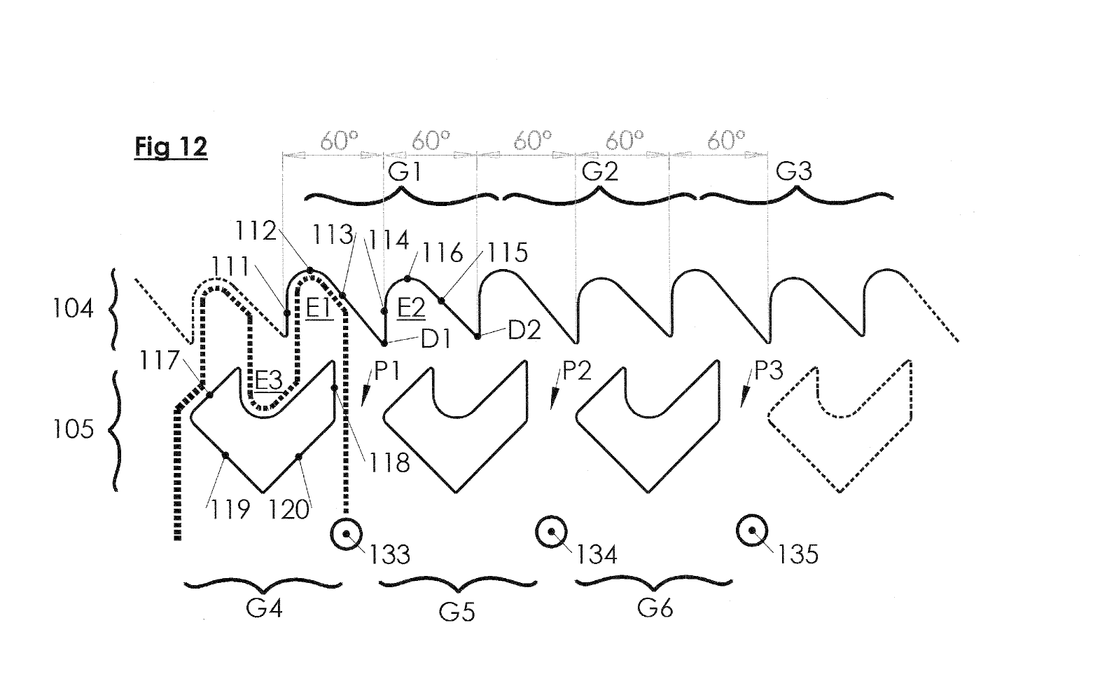

As can be seen in FIGS. 10 and 12, the upper crown 104 here has a succession of teeth oriented downwardly which constitute a cam profile. This succession here comprises three successive identical groups G₁, G₂, G₃ of teeth D₁, D₂, each group extending over 120°.

The teeth D₁, D₂ of each of these groups define two successive notches E₁, E₂ of unequal heights which extend substantially over 60°, namely:
a first notch E₁ comprising an axial edge 111, a rounded bottom 112 and an oblique edge 113, and
a second notch E₂ having a smaller height which comprises two oblique edges 114, 115 and a rounded bottom 116.

The lower crown 105 comprises three groups of cam profiles G₄, G₅ G₆, located at 120° and separated from each other by three axial passages P₁ to P₃, also located at 120° from each other, these passages P₁ to P₃ being centered on the lower part of the oblique edge 113 of the first notch E₁ of a group corresponding to the upper crown 104.

Each of these groups G₄ to G₆ comprises:
in its upper part, successively, a first oblique edge 117, followed by a notch E₃ with a rounded bottom, then an axial edge 118, and
in its lower part, two oblique edges 119, 120 defining a tooth substantially shaped like an isosceles triangle.

The releasable assembly 121 comprises a cylindrical tubular body 122 open on one side (toward the top) and closed on the other side by a back 123 provided with an opening through which the end of the halyard 109 is engaged and held, after its passage in the support assembly 101.

The tubular body 122 is partially engaged and is rotationally mounted in a tubular sleeve 124 closed toward the bottom by a solid back 125 extended by two parallel strips 126, 127, having a rounded shape.

These two strips 126, 127 are provided with two radial bores 128, 129 coaxial in relation to each other, serving for instance for fastening of the head of a sail.

The rotational assembly of the tubular body 122 in the sleeve 124 is provided through two rolling bearings 130, 131, one of which 130 has two radial tread surfaces and serves to resume the axial forces exerted on the releasable assembly 121, while the other 131 has two axial tread surfaces and serves to resume the radial forces.

The assembly formed by the rotational assembly of the tubular body on the tubular sleeve forms a swivel.

This tubular body 122 comprises three protuberances, here three cylindrical pins 133, 134, 135, protruding on its interior cylindrical surface, these three pins 133 to 135 being arranged at 120° from each other.

The operation of this device is described below.

In order to engage the releasable assembly 121 on the support assembly 101, the operators exerts tension on the halyard 109.

Under the effect of this tension, the tubular body 122 of the releasable assembly engages around the tubular section 103 of the support assembly 101 until, first, the pins 133 to 135 abut on the cam profiles of the lower crown 105.

The action of these pins 133 to 135 on the oblique edges 119, 120 of these cam profiles causes rotation of the tubular body 122 (relative to the sleeve 103) until the pins 133 to 135 are to the right of the passages P₁ to P₃.

Continuing the tension exerted on the halyard 109 then causes the engagement of the pins 133 to 135 in the passages P₁ to P₃ until they abut on the oblique edges 113 of the notch E₁ of the upper crown 104.

The cam effect produced on these oblique edges 113 then causes a new rotation of the body 122 until the pins 133 to 135 reach the bottom 112 of the notch E₁.

The operator then relaxes his effort such that the body 122 undergoes a descending travel, at the end of which the pins 133 to 135 abut on an oblique edge of the notch E₃ of the lower crown 105, driving the body 122 in rotation until the pins 133 to 135 are in the bottom of the notch E₃. The device is then in the locked position.

Unlocking in order to release the releasable assembly 121 is done by exerting new tension on the halyard 109 to cause relative axial movement of the two assemblies 101, 121, following a predetermined overtravel.

At the end of the overtravel, the pins 133 to 135 abut on the oblique edges 115 of the notch of the upper crown 104, until they arrive in the bottom of the notch E₂.

Releasing the tension force, the pins 133 to 135 again descend to engage in the passages P₁ to P₃, after having caused the body 122 to rotate upon their passage on the oblique edges 117 of the upper part of the crown 105. The releasable assembly 121 is no longer held on the support assembly 101.

Of course, the invention is not limited to the arrangements described above.

Thus, the swivel function could be provided by the support assembly 101, for example by providing for rotational assembly of the crowns 104, 105 on the tubular section 103 of the support assembly 101.

Of course, in this case, the tubular body 122 of the releasable assembly 121 may be provided with means for fastening the object to be released, for example sail (the tubular sleeve 124 no longer having a reason to exist).

1. Device for the connection/disconnection of two elements from a relative axial movement of these two elements, the two elements being able to be assembled together, so as to achieve, at the end of an assembly travel, an assembled position, then to complete, beyond this assembled position, a locking/unlocking overtravel, one of said elements comprising a locking member in the assembled position of the two elements, this member being able to pass successively from a released position in which it allows the assembly and disassembly of the two elements to a locked position in which it cooperates with the other element to provide locking,
said device comprising means for actuating the locking member from said overtravel, these means having a bistable operation, such that a first overtravel causes the locking member to go from the released position to the locked position and such that the following overtravel causes the return of the locking member of the released position.

2. Device according to claim 1,
wherein one of the two elements (the first) comprises a rotary annular locking member comprising two axially distant cam profiles, designed to cooperate respectively with at least two axially distant stop surfaces provided on the second element, the first cam profile being designed so as to cause the rotation of the locking member under the action of the first stop surface, during said overtravel, and wherein the second cam profile is designed so as to cooperate with the second stop surface of the second element, so as to cause the rotation of the locking member during a return travel to the assembled position and to axially retain this second element in the assembly position when the locking member is in the locked position.

3. Device according to claim 1,
wherein said first element of the female type comprises a tubular body inside which is rotationally assembled a locking member comprising a tubular section having a cylindrical shape inside which are arranged:
on one hand, a coaxial crown whereof one of the radial surfaces is formed so as to make up a cam surface having four successive notches each having a straight front followed by a partially cylindrical portion and a slightly tilted ramp,
on the other hand, a coaxial cylindrical part having an axial through passage with a rectangular cross-section centered on the axis of the tubular sleeve, this cylindrical part being located away from the crown and having, on the side of said crown, a radial surface comprising four successive notches similar to those of the crown and also comprising a straight front, a partially cylindrical portion and a slightly tilted ramp, the notches of said crown being angularly offset relative to the notches of the cylindrical part.

4. Device according to claim 1,
wherein one of said elements comprises means allowing its fastening to a support structure such as the head of a sailboat mast, and in that the other element comprises means allowing its fastening to a releasable structure such as a sail.

5. Device according to claim 1,
wherein one of the two elements comprises a locking member comprising at least two axially distant cam profiles, designed to cooperate with at least first and second stop surfaces provided on the second element, respectively, the first cam profile being designed so as to cause a relative rotation between the locking member and said stop surfaces following the tension exerted during said overtravel, between the first stop surface and said profile and wherein the second cam profile is designed so as to cooperate with the second stop surface of the second element so as to cause a relative rotation between the locking member and said stop surfaces during inverse return travel of said overtravel, to the assembled position, and to bring said locking member and/or the second stop to the locked position.

6. Device according to claim 5,
wherein said first element is a support assembly of the male type bearing a locking member comprising two axially offset indented crowns forming said cam profiles, and wherein said second element is a releasable assembly comprising a rotary tubular body bearing said stop surfaces.

7. Device according to claim 6,
wherein one of the crowns (upper crown) has a continuous succession of teeth oriented downwardly which forms the first cam profile, this succession comprising three identical groups of teeth which each extend over 120°, wherein the other crown (lower crown) comprises three groups of cam profiles located at 120° from each other separated by three axial passages, and wherein said tubular body comprises three protuberances located at 120° from each other, protruding relative to the interior surface of said body, these protuberances being formed so as to be able to go in said passages and to present said stop surfaces.

8. Device according to claim 7,
wherein said protuberances have a cylindrical shape centered radially relative to said body.

9. Device according to claim 7,
wherein said groups of teeth of the upper crown form two successive notches of unequal heights, which each extend over approximately 60°, namely a first notch defined by a substantially axial edge, a rounded bottom and an oblique edge, and a second notch having a smaller height which comprises two oblique edges and a rounded bottom, and in that each of the groups of the lower crown comprises, in its upper part, successively, a first oblique edge followed by a notch having a rounded bottom, then an axial edge, and in its lower part, two oblique edges defining a substantially triangular tooth, said axial passages being located opposite the oblique edge of the notch having the larger height of the upper crown.

10. Device according to claim 6,
wherein said tubular body is rotationally assembled in a tubular sleeve, provided with fastening means for a releasable element, so as to form a swivel.

11. Device according to claim 6,
wherein said first element comprises a cylindrical tubular section bearing the two aforementioned indented crowns on its outer cylindrical surface, this cylindrical section being open on one side and being made integral from the other side with a yoke which defines a radial through passage having an oblong cross-section wherein is rotationally assembled a pulley on which a halyard passes, the end of said halyard being fixed on the tubular body of the second element.

12. Device according to claim 11,
wherein the upper part of the yoke has a solid shape provided with a radial passage forming a fastening guide.

13. Device according to claim 6,
wherein said locking member bearing the two cam profiles is rotationally assembled on the support assembly.

14. Device according to claim 1,
wherein the support element is assembly on the head of a sailboat mast and, in that the releasable assembly is made integral with a sail.
